(19) United States
(12) Patent Application Publication
(10) Pub. No.: US 2004/0166940 A1
(43) Pub. Date: Aug. 26, 2004

(54) Configuration of gaming machines

(76) Inventor: Wayne H. Rothschild, Northbrook, IL (US)

Correspondence Address: Michael J. Blankstein, WMS Gaming Inc., 3401 N. California Ave., Chicago, IL, 60618, US

(21) Appl. No.: 10/375,855

(22) Filed: Feb. 26, 2003

(51) Int. Cl. G06F 17/00

(52) U.S. Cl. 463/42

(57) ABSTRACT

A system and method of configuring gaming machines includes one or more databases, an electronic trend analyzer, and a host computer system. The databases collect and store data associated with a plurality of variables. The plurality of variables include a dependent variable and a plurality of independent variables. The dependent variable is indicative of performance of the gaming machines. The trend analyzer uses inferential statistics to identify a previously unknown relationship between the dependent variable and one or more of the independent variables. The host computer system is linked to the gaming machines and is adapted to configure the gaming machines based on the identified relationship.

### REFERENCE TO RELATED APPLICATIONS

This application is related to U.S. patent application Ser. No. 09/778,351 (Attorney Docket No. 47079-087) filed on Feb. 7, 2001 and entitled “Centralized Gaming System with Modifiable Remote Display Terminals”, and U.S. application Ser. No. 10/092,072 (Attorney Docket No. 47079-0125) filed on Mar. 6, 2002 and entitled “Integration of Casino Gaming and Non-Casino Interactive Gaming”.

### FIELD OF THE INVENTION

The present invention relates generally to gaming machines and, more particularly, to a system and method for configuring gaming machines based on inferential statistical analysis, such as regression analysis, of collected data to reveal previously unknown relationships in the data.

### BACKGROUND OF THE INVENTION

Electronic gaming machines have been a cornerstone of the gaming industry for several years. They are operable to play such wagering games as mechanical or video slots, poker, bingo, keno, and blackjack. Generally, the popularity of such gaming machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or perceived to be the same), players are most likely to be attracted to the most entertaining and exciting of the machines. Accordingly, shrewd operators (e.g., casinos) consequently strive to employ the most entertaining and exciting machines available because such machines attract frequent play and hence increase profitability to the operator.

At the same time, operators want to maximize their relationships with players to obtain greater profitability-through-customer loyalty. Operators are increasingly implementing customer relationship management (CRM) software and services to pool essential player tracking data from all casino and hotel departments into a global storage system. Such data may, for example, include gender, age, where a player lives, games played, and coins played per game and is used to identify high-value (big-spending) customers. After identifying the high-value customers, the operator offers them appropriate marketing promotions with tight expiration dates to encourage the customers to either return sooner to the operator's casino or switch a visit from a competitor to the operator's casino. The marketing promotions may, for example, include direct-mail discounts, complimentaries on hotel rooms, or transportation for customers who live far away from the operator's casino, and food, entertainment, or cash incentives for drive-in customers.

Heretofore, operators have primarily used the valuable data derived from a CRM offering to develop marketing promotions that entice high-value customers to return to the casino. Once the high-value customers have returned to the casino, it would be desirable to entice such customers to stay at the casino and, in particular, to maintain the interest of such customers while they play the casino's electronic gaming machines and maximize the performance and profitability of the machines. After all, gaming machines account for a significant percentage of a typical casino's operating profit.

### SUMMARY OF THE INVENTION

In accordance with the present invention, a system and method of configuring gaming machines includes one or more databases, an electronic trend analyzer, and a host computer system. The databases collect and store data associated with a plurality of variables. The plurality of variables include a dependent variable and a plurality of independent variables. The dependent variable is indicative of performance of the gaming machines. The trend analyzer uses inferential statistics to identify a previously unknown relationship between the dependent variable and one or more of the independent variables. The host computer system is linked to the gaming machines and is adapted to configure the gaming machines based on the identified relationship.

### BRIEF DESCRIPTION OF THE DRAWINGS

The foregoing and other advantages of the invention will become apparent upon reading the following detailed description and upon reference to the drawings.

FIG. 1 is a block diagram of a system and method for integrating casino gaming with non-casino interactive gaming in accordance with the present invention.

FIG. 2 is a flow diagram of steps performed by a trend analysis computer in developing and specifying a regression model for regressing a dependent variable onto one or more independent variables.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF ILLUSTRATIVE EMBODIMENTS

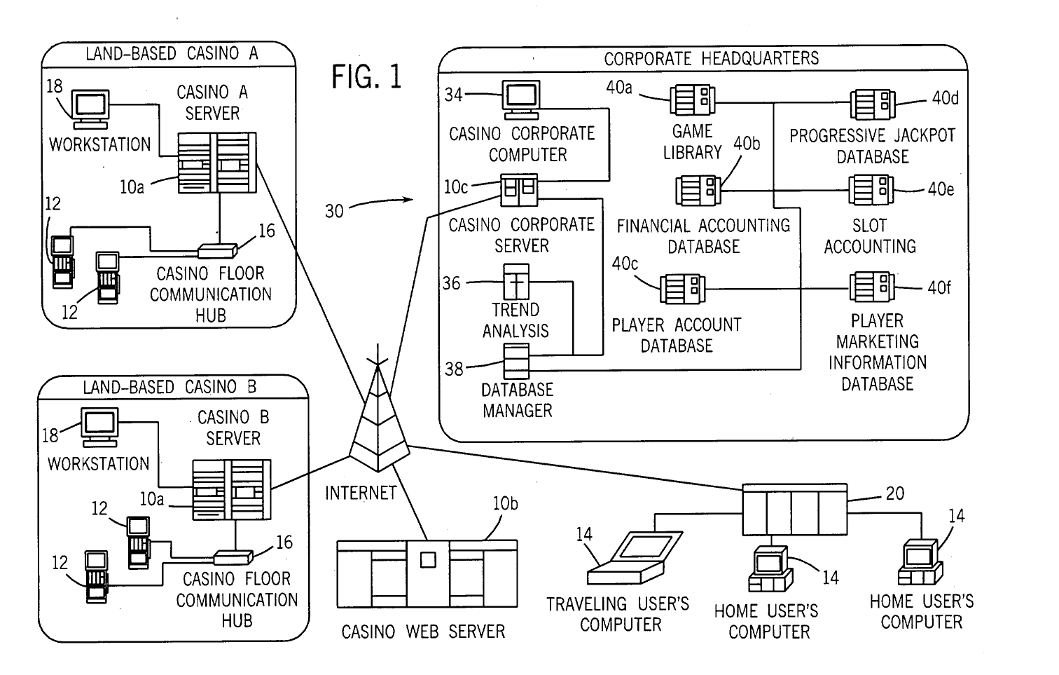

Turning now to the drawings, FIG. 1 depicts a web-based system for integrating casino gaming with non-casino interactive gaming. The system includes a central server system 10, a plurality of player-operated gaming machines 12, and a plurality of player-operated computing devices 14. The central server system 10 may include the local casino servers 10a, the casino web server 10b, and/or the casino corporate server 10c. The central server system 10 offers a plurality of wagering games in such categories as slots, poker, bingo, keno, and blackjack. The gaming machines 12 are located in one or more land-based casinos and linked to the central server system 10 by a reconfigurable, multi-site computer network such as an intranet. The computing devices 14 are remote from any land-based casino and, with proper authorization, linked to the central server system 10 by the Internet. The wagering games may be conducted via either the gaming machines 12 or the computing devices 14.

Thus, the system in FIG. 1 may, for example, be a web-based system utilizing an intranet and the Internet. An intranet is a network based on TCP/IP (Transmission Control Protocol/Internet Protocol) protocols belonging to an organization, usually a corporation, accessible only by the organization's members, employees, or others with authorization. In the illustrated system, the intranet is used to securely network the gaming machines 12 to each other and the central server system 10. The casino web server 10b operates the intranet's web site and posts the plurality of wagering games on the web site. The web site looks and acts just like any other web sites, but a firewall surrounding the intranet fends off unauthorized access. With proper authorization, non-casino-based computing devices 14 may access the intranet via the Internet and therefore be linked to the central server system 10 and even the gaming machines 12 if necessary. By opening the intranet operating in the land-based casinos to the non-casino-based computing devices 14, players can play the same wagering games at the casino and away from the casino. Therefore, casinos can have one central slot tracking system and one central data repository, e.g., at a corporate headquarters 30, for all land-based and cyberspace operations. Although the system in FIG. 1 is illustrated as being a web-based system utilizing an intranet and the Internet, other types of gaming networks may be utilized.

A wagering game is generally conducted by receiving a wager from a player, generating a random event, and providing an award to the player for a winning outcome of the random event. The term “random” as used herein in intended to encompass both a truly random event and a pseudo-random event. A wagering game includes audiovisual content and game software (i.e., decision logic) for generating the random event. The audiovisual content includes sounds, images, and animations. The game software includes a random number generator (RNG) and game play routines directing the sequence of play of the wagering game.

When a wagering game is conducted via a gaming machine 12, the wagering game may be conducted at a central server level, a machine level, or a hybrid server/machine level depending upon how the machine and the system are set up. When the wagering game is conducted at the server level, the game's audiovisual content and game software are executed at the central server system 10 by, for example, the local casino server 10a in the same casino as the gaming machine 12. In this case, the gaming machine 12 may be free of a game engine for executing the game software and primarily serve as a display terminal. When the wagering game is conducted at the machine level, the audiovisual content and game software are executed at the gaming machine 12. To allow the gaming machine 12 to execute the audiovisual content and game software, this information is downloaded from the central server system 10 to the gaming machine 12 and stored locally on the gaming machine prior to conducting the wagering game. When the wagering game is conducted at the hybrid server/machine level, the audiovisual content is executed at the gaming machine 12 while the game software is executed at the central server system 10. To allow the gaming machine 12 to execute the audiovisual content, the audiovisual content is downloaded from the central server system 10 to the gaming machine 12 and stored locally on the gaming machine prior to conducting the wagering game.

When a wagering game is conducted via a computing device 14, the wagering game may be conducted at a central server level or a hybrid server/device level depending upon how the device and the system are set up. When the wagering game is conducted at the server level, the game's audiovisual content and game software are executed at the central server system 10 preferably by the casino web server 10b. When the wagering game is conducted at the hybrid server/device level, the audiovisual content is executed at the computing device 14 while the game software is executed at the central server system 10. To allow the computing device 14 to execute the audiovisual content, the audiovisual content is downloaded from the central server system 10 to the computing device 14 and stored locally on the computing device prior to conducting the wagering game. In order to make wagering games conducted via a computing device 14 verifiable, the random event must be generated at the central server system 10. Therefore, a wagering game may not be conducted solely at a device level.

In one embodiment, each wagering game is offered in two distinct versions: basic and enhanced. On the one hand, the basic version is conducted at the server level such that it is played over the network using JavaScript or other open or proprietary language. The basic version allows a player to quickly sample a wagering game. On the other hand, the enhanced version includes upgraded audiovisual content that is downloaded from the central server system 10 to the machine or computing device used to conduct the wagering game. Instead of downloading the upgraded audiovisual content from the central server system 10, such content may be distributed to the appropriate machine or computing device from other storage media (EPROM, CD-ROM, hard disk, etc.) that are either installed directly in the machine or device or are linked to the machine or device for downloading the content thereto. The upgraded audiovisual content is stored locally on that machine or computing device. The enhanced version treats the player with a more exciting and entertaining multimedia experience than the basic version. When the enhanced version is conducted via a gaming machine 12, the enhanced version may be conducted at either the machine level or the hybrid server/machine level. When the enhanced version is conducted via a computing device 14, the enhanced version may be conducted at the hybrid server/device level.

The central server system 10 may include the local casino servers 10a, the casino web server 10b, and/or the casino corporate server 10c. Each server includes a microprocessor, a clock, and an operating system associated therewith. The microprocessor executes instructions from its read only memory (ROM) and, during such execution, the microprocessor temporarily stores and accesses information from a random access memory (RAM).

In one embodiment, the local casino server 10a is responsible for accumulating and consolidating data generated from casino-based gaming and transmitting such data between the casino corporate server 10c and the gaming machines 12 in the same casino as the server 10a. When a wagering game is conducted via a gaming machine 12 at a server level or a hybrid server/machine level, the local casino server 10a is also responsible for executing all or a portion of the wagering game. The casino web server 10b is responsible for accumulating and consolidating data generated from non-casino-based gaming and transmitting such data between the casino corporate server 10c and the computing devices 14. The casino web server 10b is also responsible for executing all or a portion of a wagering game conducted via a computing device 14.

In another embodiment, the local casino servers 10a merely serve as pass-through components. The casino web server 10b is responsible for accumulating and consolidating data generated from both casino-based gaming and non-casino-based gaming and transmitting such data between the casino corporate server 10c and both the gaming machines 12 and the computing devices 14.

The gaming machines 12 are networked to each other and the central server system 10 by the intranet. The gaming machines 12 in each land-based casino are linked by a high-speed local area network, such as a wireless or wired Ethernet. Each local area network supports standard Internet protocols, such as TCP/IP, for transmitting data over the local area network and transmitting data between the local area network and the central server system 10. Each local area network may include the local casino server 10a, a casino floor communications hub 16, and a workstation 18. The local casino server 10a may include a gateway that serves as an entrance to the local area network. The gateway is associated with a router, which knows where to direct a given packet of data that arrives at the gateway, and a switch, which furnishes the actual path in and out of the gateway for a given packet. The casino floor communications hub 16 consolidates data transferred to and from the gaming machines 12. The workstation 18 may be used to program, control, and monitor the gaming machines 12 at the local casino level.

Each gaming machine 12 has the appearance of a typical upright or slant-top video gaming machine. The gaming machine 12 includes a cabinet and at least one video display mounted within the cabinet. The cabinet is situated on either a floor of the casino or a stand resting on the floor. A player may operate the gaming machine 12 via either physical button panel below the video display or a touch screen overlying the video display. To help differentiate the casino-based gaming machines 12 from the non-casino-based computing devices 14, the gaming machines 12 couple the genuine feel of a typical gaming machine with large display screens, excellent graphics, hi-fidelity sound, and other physical attributes.

The computing devices 14 may, for example, include a personal computer (portable or desktop), Internet appliance, personal digital assistant, wireless telephone, and pager. Depending upon the device, the computing devices 14 may be used at home, in a hotel room, or while traveling. The computing devices 14 are remote from any land-based casino, although they may be used in a hotel room, by the pool, in the fitness room, or in some other facility of a hotel containing a casino. Each computing device 14 preferably includes a central processing unit (CPU) and various peripherals linked to the CPU. If the computing device 14 is a personal computer, for example, the peripherals may include a video display, a keyboard, a mouse, and a touch screen overlying the video display. The CPU executes instructions from its read only memory (ROM) and, during such execution, the CPU temporarily stores and accesses information from a random access memory (RAM). If a computing device 14 is to access the above-noted intranet via the Internet, the computing device 14 must initially access the Internet through an Internet Service Provider (ISP) 20 (also known as Internet Access Provider (IAP)) and communicate with the Internet using standard Internet protocols such as TCP/IP.

One or more security measures protect the intranet from unauthorized access. Therefore, after accessing the Internet, the computing device 14 must circumvent these security measures to access the intranet and, more specifically, the gaming web site operated by the casino web server 10b. One security measure may require the computing device 14 to be equipped with a proper hardware or software security key enabling the computing device 14 to access the intranet and the gaming web site. The security key may be linked to a global positioning system to enable the location of the computing device 14 to be tracked for tax and legality purposes. To access the gaming web site, a player enters the host name and the domain name for the web site in the address field of the web browser used by the player to navigate the Internet. Another security measure may require a player to log into the “secure” gaming web site using such login information as a user name and password that are previously registered (see below) with the casino that operates the web site. Without the correct login information, the player is denied access to all but the login page(s) of the gaming web site or, alternatively, is denied access to only those portions of the web site involving wagering.

The registration procedure may require the player to open a record or “house” account at a registration facility of the casino. The player's account is stored in a database at the corporate headquarters 30 and/or the casino web server 10b. During the registration procedure, the casino may require the player to submit various types of player tracking information to be stored in the player's account, including name, date of birth, social security number, address, telephone number(s), and other requisite information. As discussed below, the player may also provide other types of optional player tracking information. The casino preferably requires the player to verify his or her identity with one or more commonly accepted forms of identification, such as a driver's license, passport, social security card, etc. The login information for logging into the gaming web site may be selected by the casino or the player and then stored in the player's account. The casino provides the registered player with the hardware or software security key to install on the player's computing device 14 to enable the computing device to access the intranet. The casino may limit the registered player to a single security key for installation on a single computing device 14 or, if requested by the player, may provide the player with multiple security keys for installation on multiple computing devices 14.

Once a computing device 14 is granted full access to the gaming web site operated by the casino web server 10b, the player may proceed to play the wagering games available on the web site. The web site may identify numerous gaming categories and present such categories with hyperlinks. The categories may, for example, include slots, poker, bingo, keno, and blackjack. Under each category, the web site may identify specific wagering games available for play and may allow a player to commence play of such games with respective hyperlinks. The slots category may, for example, include a library of slot games.

The gaming web site may be set up to accept wagers by electronic funds transfer (EFT) from one or more monetary sources. One monetary source may be a credit card, in which case the player must provide the casino web server 10b with credit card information (e.g., credit card type, number, and expiration date) either during the registration procedure (see above) or upon login to the gaming web site. Another monetary source may be money stored in the player's house account, in which case the player must deposit money into the house account or arrange for a line of credit in the house account during the registration procedure. The casino web server 10b deducts wagers from the monetary source and adds payoffs for winning game outcomes to the monetary source.

The corporate headquarters 30 includes a corporate casino computer 34, the casino corporate server 10c, a trend analysis computer 36, a database manager 38, and various databases 40a-g. The foregoing items may be physically separated into distinct hardware components that are linked over the network, or may be physically combined into one or more hardware components and only logically separated from each other. The corporate casino computer 34 may be used to program, control, and monitor the gaming machines 12 and the computing devices 14 at the corporate level and view the data accumulated in the various databases 40a-g. The casino corporate server 10c is linked to the intranet for transferring data to and from the intranet.

The database manager 38 manages data acquired from the intranet by the casino corporate server 10c and routes the acquired data for storage in the appropriate databases 40a-g. The game library database 40a stores a plurality of wagering games. The corporate casino computer 34 may cause the database manager 38 to selectively access the wagering games in the game library database 40a and download the selected games to the local casino servers 10a and/or the casino web server 10b. The local casino servers 10a may, in turn, download a portion or all of each selected game to some or all of the gaming machines 12 in their respective casinos. The financial accounting database 40b stores general financial accounting information. The hotel/casino database 40c may, for example, include such hotel/casino guest information as payment method, whether baggage was checked, whether valet was used for a vehicle, length of stay, type of room (e.g., smoking, non-smoking, suite, number of beds, type of bed(s), handicapped, etc.), number of guests per room, historical stay at hotel chain, use of spa, use of fitness center, use of restaurants, use of stores for shopping, use of room service, use of other hotel facilities, spending at hotel facilities, etc. The progressive jackpot database 40d may, for example, indicate how many progressive jackpots are operating, where the jackpots are operating, how much money is in each operating jackpot, what jackpots were paid out, and when the jackpots were paid out.

The slot accounting database 40e may, for example, include profit, utilization, credits in, credits out, credits played, credits won, jackpots and other prizes won, titles of games played, theme type (e.g., animals, people, brand, photos, cartoons, etc.), game type (e.g., mechanical slots, video slots, video poker, video keno, video blackjack, video bingo, table games, etc.), machines played, denominations of games played (e.g., nickel, dime, quarter, half-dollar, dollar, etc.), frequency of play of each denomination, number of games played, duration of play, specific times of play (e.g., time of day, week, month, and year), time between games, contemporaneous events (e.g., fight night, concerts, tradeshows, etc.), days since first installation of titles on the casino floor, days since first installation of machines on the casino floor, locations of titles on the casino floor, locations of machines on the casino floor, maximum number of credits that can be wagered, average number of credits wagered, median number of credits wagered, average number of lines played, median number of lines played, type of bonus feature (e.g., free spins, second screen bonus, both, neither, prize, etc.), overall payback percentage, base game payback percentage, bonus game payback percentage, hit frequency, hit frequency of bonus round, volatility index, predominant glass color, cabinet finish, door finish (e.g., chrome, gold, or paint), sound (style of music), top award size, consistency of credits played (hand to hand), top box style, and type of casino (e.g., independent or chain). Of course, the amount and types of collected game accounting data may be varied to suit a particular casino. The corporate casino computer 34 may compile an accounting report based on the accounting data from each of the individual gaming machines 12 and computing devices 14, and the report may, in turn, be used by management to assess the performance and profitability of the machines 12 and devices 14. The accounting data allows the trend analysis computer 36 to analyze the performance of each wagering game, each gaming location, individual gaming machines 12 and computing devices 14, groups of gaming machines 12 and computing devices 14, etc.

When a player enrolls in a casino's player tracking system, often called a “slot club” or a “rewards program,” the casino issues a player identification card that has encoded thereon a personal identification number that uniquely identifies the player. The identification card may, for example, be a magnetic card or a smart (chip) card. The personal identification number is associated with a unique record stored in the player account database 40f. The player account database 40f includes multiple records or “house accounts” each having data associated with such player tracking variables as background variables, game preference variables, and some or all of the usage variables included in the casino/hotel database 40c, the progressive jackpot database 40d, and the slot accounting database 40e.

When the player enrolls in the casino's player tracking system, the player may provide data associated with the background variables and game preference variables. The background variables may, for example, include name, home address, date of birth (or age), social security number, telephone number(s), credit card information, gender, types of owned/leased vehicles, ethnicity, hair color, eye color, height, weight, left or right-handedness, marital status, number of children, age of children, clothing size, shoe size, favorite clothing designers, favorite sports, favorite sports teams, favorite color, favorite television shows, favorite music, favorite foods, favorite restaurants, favorite beverages, hobbies, vocation, income level, activity level, frequency of use of the Internet, duration of use of the Internet, purposes for using the Internet, frequent flier point level and memberships, magazine subscriptions, and political affiliation. The game preference variables may, for example, include preferred game titles, preferred game categories (e.g., slots, poker, keno, bingo, blackjack, etc.), preferred game themes, preferred default game configuration (e.g., language, sound options, denomination, speed of play, speed of reel spins for a slot game, number of pay lines played for a slot game, number of credits played per pay line per reel spin for a slot game, etc.), and preferred distribution of awards (e.g., payout structure, payout options, form of complimentaries, denomination, etc.). It should be understood that the above lists of variables are by no means exhaustive and that other variables are possible.

Some or all of the usage variables in the casino/hotel database 40c, the progressive jackpot database 40d, and the slot accounting database 40e may also be used in the player account database 40f to track the activity of individual players (when such players identify themselves with their personal identification cards while using the casino/hotel facilities, the gaming machines 12, and the computing devices 14). With respect to the gaming machines 12, for example, each gaming machine 12 is fitted with a card reader into which the player inserts his or her identification card prior to playing the associated machine 12. The card reader reads the personal identification number off the card. The personal identification number is associated with a unique record stored in the player account database 40f. Instead of or in addition to player identification cards, the identities of players may be established by reading a biometric attribute (e.g. voice, iris, retina, fingerprint, handwriting, and face) of a player that is compared to a reference attribute stored in the player account database 40f. With respect to the computing devices 14, a player's login information may be associated with a unique record stored in the player account database 40f. If the player at the computing device 14 also has an identification card for use in a casino, the login information and the card may be tied to separate records or to separate sections of a common record. Whether a player is using a gaming machine 12 or a computing device 14 to play games, the machine or device transmits the usage data for the player's subsequent gaming activity to the slot accounting database 40e and transmits some or all of that data to the associated unique record stored in the player account database 40f. Thus, the player identification cards aids the casino in knowing more about who its patrons are and what they like.

The player marketing information database 40g indicates, for example, the identities of players, which wagering games are being played, where the wagering games are being played, when the wagering games are being played, and how much or how long the wagering games are being played. This marketing information can, in turn, be used to assess playing habits, offer complimentaries, and engage in other types of target marketing. In addition to the various databases 40a-g identified above, the database manager 38 may manage other databases such as a tourism database.

In one embodiment, the gaming machines 12 only offer the enhanced versions of wagering games, and the enhanced versions are conducted via the gaming machines 12 at the hybrid server/machine level described above. When a gaming machine 12 is initially installed and put into service, the upgraded audiovisual content of one or more wagering games is downloaded to the gaming machine 12 from the central server system 10. The initial selection of downloaded games may be determined, in part, on trends established by the trend analysis computer 36. If it is desirable to subsequently download any new wagering games after the gaming machine 12 has already been put into service, the upgraded audiovisual content of such new games may be downloaded to the gaming machine 12 in the background without disrupting (i.e., taking offline) the operation of the gaming machine 12. The gaming machines 12 may be configured to offer any or all of the wagering games available for play via the computing devices 14. New or special wagering games may be offered only for play via the gaming machines 12 or the computing devices 14. Some of the gaming machines 12 may be dedicated to a single wagering game.

The trend analysis computer 36 uses inferential statistics, such as correlation and regression, to reveal previously unknown relationships in the data collected in the databases 40a-g. The revealed relationships, in turn, are used to configure the gaming network in a manner that maintains the interest of players and/or maximizes the performance and profitability of the machines and devices. Configuration may, for example, involve selections as to what wagering games are downloaded, when the games are downloaded, where the games are downloaded, what specific features are included in the games, how the games and/or machines are customized for a particular player, etc. More specifically, configuration commands may be directed to specified games, machines, or areas of a casino floor. With respect to such specified games, machines, or floor areas, the configuration commands may change the minimum wager (denomination), change game themes, change the payback percentage, change the hit frequency, change the volatility index, change certain machines from offering multiple games to offering a single game, change the color scheme of themes, enable or disable bonus events, change the type of bonus, enable or disable progressives, completely disable certain gaming machines, run time-based (e.g., happy hour) type promotions such as extra jackpots, change the sounds of a game, selectively allow free play, eliminate a game from a casino floor selection based on house winnings, change number of lines available to wager on a given theme, change theme adjacency or themes mixed on a bank of gaming machines, change themes to be in a position adjacent to a known player, suggest games to players, etc.

Based on the relationships discovered by the trend analysis computer 36, the trend analysis computer 36 recommends configuration changes to the central server system 10. In response to these recommendations, the central server system 10 may initiate a configuration change automatically or in response to an operator input at the central server system 10 confirming acceptance of the change. Inferential statistics and its use for configuring the gaming system are described below.

By way of background, statistics is a set of tools used to organize and analyze data. Data must either be numeric in origin or transformed by researchers into numbers. Employing statistics serves two purposes: (1) description and (2) prediction. Statistics are used to describe the characteristics of groups. These characteristics are referred to as variables. Data is gathered and recorded for each variable. Descriptive statistics can then be used to reveal the distribution of the data in each variable. Inferential statistics are used to draw conclusions and make predictions based on the descriptions of data.

Prediction is based on the concept of generalization—if enough data is compiled about a particular context, the patterns revealed through analysis of the data collected about that context can be generalized to (or predicted to occur in) similar contexts. The prediction of what will happen in a similar context is probabilistic. That is, the researcher is not certain that the same things will happen in other contexts; instead, the researcher can only reasonably expect that the same things will happen. Precise probabilities are determined in terms of the percentage chance that an outcome will occur, complete with a range of error.

Regression and correlation analysis are statistical techniques used to examine causal relationships between variables. These techniques measure the degree of relationship between two or more variables in two different but related ways.

In regression analysis, a single dependent variable, Y, is considered to be a function of one or more independent variables, X₁, . . . , Xₖ. The values of both the dependent and independent variables are assumed as being ascertained in an error-free random manner. Further, parametric forms of regression analysis assume that for any given value of the independent variable, values of the dependent variable are normally distributed about some mean. Application of this statistical procedure to dependent and independent variables produces an equation that “best” approximates the functional relationship between the data observations.

More specifically, the primary elements of regression analysis include:

A dependent variable Y, which is what one really cares about;

Independent variables X₁, . . . , Xₖ, which can be directly observed or controlled;

A regression model, which one believes describes the general nature of the relationship between Y and the X's:

Y=αf+β₁X₁+ . . . +βₖXₖ+ε

where (i) (α, β₁, . . . , βₖ) are constants that describe the population and (ii) ε is a residual error term that summarizes the role of all relevant variables other than the X's in the relationship.

Sample data consisting of the values of Y and all of the X's.

The regression model asserts that the value of a variable Y depends on the X's and on other things. The model asserts that the relationship between Y and the X's is linear. It should be noted that (i) some relationships are linear; (ii) many non-linear relationships can be transformed into linear ones; and (iii) every smooth globally-nonlinear relationship is locally linear. Key assumptions concerning the model are that (i) the value of a is set so that E|ε|=0; (ii) ε varies approximately normally across the population, with the same variance for all values of the X's; and (iii) ε is uncorrelated with the independent variables.

The trend analysis computer 36 finds the linear function which fits the sample data best (in the sense that the sum of the squared residuals will be as small as possible):

Y_{pred}=a+b₁X₁+ . . . +bₖXₖ.

where (a, b₁, . . . , bₖ) are unbiased estimates of (α, β₁, . . . , βₖ), and the prediction equation yields the best estimate one can make of Y, if all one knows are the X's.

Associated results of a regression analysis and their uses are shown in the table below:

| statistic | symbol | value | use/interpretation |
|---|---|---|---|
| standard error of | s_{ε} | an estimate, from | to construct rough 95%- |
| regression | | the sample data, of | confidence intervals for |
| | | the standard | predictions made for |
| | | deviation of ε | individuals |
| the coefficient of | r² | 1 − Var(ε)/Var(Y) | the fraction of the variance of |
| determination | | | Y (across the population) |
| | | | which can be explained by the |
| | | | fact that the X's vary |
| standard error(s) | s_{b1}, . . . ,s_{bk} | one standard- | to construct 95%-confidence |
| of the | | deviation's worth of | intervals for β₁, . . . , βₖ, the true |
| coefficient(s) | | sampling error in | coefficients in the relationship |
| | | b₁, . . . , bₖ, which are | describing the population |
| | | estimates of β₁, . . . , | |
| | | βₖ | |
| t-ratio(s) of the | | b₁/s_{b1}, . . . , bₖ/s_{bk} | to test null hypotheses of the |
| coefficient(s) | | | form H₀: βᵢ = 0; a large t-ratio |
| | | | (e.g., greater than 1.96 at the |
| | | | 5% level) indicates that, on the |
| | | | basis of the data alone, there is |
| | | | strong evidence supporting the |
| | | | inclusion of Xᵢ in the model |
| the beta-weights | | b₁ · σ_{X1}/σ_{Y}, . . . , | the relative importance of |
| (standardized | | bₖ · σ_{Xk}/σ_{Y} | variation in each of the X's, in |
| regression | | | explaining the observed |
| coefficients) of | | | variation in Y (across the |
| the independent | | | population) |
| variables | | | |

Correlation analysis measures the degree of association between two or more variables. Parametric methods of correlation analysis assume that for any pair or set of values taken under a given set of conditions, variation in each of the variables is random and follows a normal distribution pattern. Utilization of correlation analysis on dependent and independent variables produces a statistic called the correlation coefficient r. The square of this statistical parameter (the coefficient of determination or r²) describes what proportion of the variation in the dependent variable is associated with the regression of an independent variable. In the context of regression analysis, the correlations between the independent variables may yield additional insight into the nature of the population being studied. In a simple linear regression (i.e., only one independent variable), the single beta-weight happens to be equal to the correlation between the dependent and independent variables, and the square of the correlation is the coefficient of determination. The “normalized” (simple) prediction equation, (Y_{pred}−Y)/σ_{Y}=Corr(X,Y)·((X−X)/σ_{X}), helps explain the phenomenon of regression to the mean.

The related notion of covariance provides a general formula for the variance of the sum of two random variables:

Var(X+Y)=Var(X)+Var(Y)+2·Cov(X,Y).

Analysis of variance is used to test the significance of the variation in the dependent variable that can be attributed to the regression of one or more independent variables. Employment of this statistical procedure produces a calculated F-value that is compared to a critical F-value for a particular level of statistical probability. Obtaining a significant calculated F-value indicates that the results of regression and correlation are indeed true and not the consequence of chance.

An important aspect of regression analysis is for the trend analysis computer 36 to specify a regression model, which involves deciding which variables “belong” in the model and which variables should be excluded from the model. During the modeling process, the trend analysis computer 36 attempts to minimize potential problems.

One problem that the trend analysis computer 36 attempts to minimize is specification bias, i.e., including too few variables in the model. Specification bias arises when a potential independent variable that is related to both the dependent variable and an included independent variable is omitted from the regression model. The result is a biased estimate of the coefficient of the included variable, which is forced to play a double role.

In making a prediction for a dependent variable Y, there are two separate sources of error:

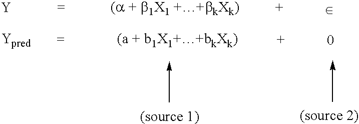

Exposure to error from sources 1 and 2, respectively, is measured by (1) the standard error of the estimated mean at (X₁, . . . , Xₖ) and (2) the standard error of the regression. Item (1) measures exposure to sampling error in estimating the true regression coefficients. The larger the sample, the smaller the exposure to sampling error. Item (2) measures exposure to error due to the incompleteness of the regression model. This exposure will persist no matter how large the sample may be. The standard error of the prediction combines these two measures by taking the square root of the sum of the squares, i.e., converting standard deviations to variances, summing, and converting back to a standard deviation again, to yield a measure of total exposure to error in making an individual prediction. Confidence intervals for individual predictions are based on the standard error of the prediction.

Another problem that the trend analysis computer 36 attempts to minimize when specifying a regression model is colinearity, i.e., including too many variables in the model. If two independent variables are highly correlated, or if three or more are closely linearly related, then it is not possible to estimate their separate effects via regression analysis. If one or the other truly belongs in the regression model, then the trend analysis computer 36 will find that:

(1) when either is included in the analysis and the other is excluded, the t-ratio of the included variable is large, but

(2) when both are included in the analysis, both t-ratios are small because there will be substantial uncertainty in the estimates of the two coefficients, resulting in large standard errors of the coefficients.

If both variables appear to be measuring the same thing, the computer 36 may include the one that seems to be the better measure and exclude the other. If, however, the two variables are truly measuring different things, the computer 36 may include them both and check the standard error of the prediction when making predictions.

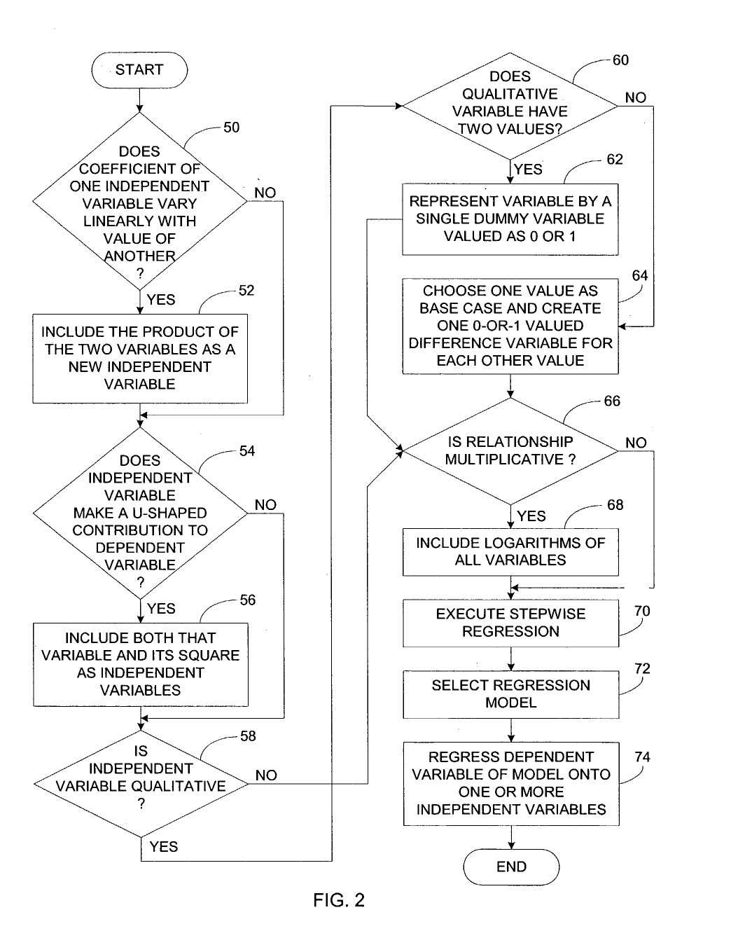

FIG. 2 is a flow diagram of basic steps performed by the trend analysis computer in developing and specifying a regression model for regressing a dependent variable Y onto one or more independent variables X₁, . . . , Xₖ. To begin with, the trend analysis computer 36 may utilize four common modeling tricks when developing a regression model.

First, if the computer 36 determines that the coefficient of one independent variable varies linearly with the value of another at step 50, the regression model may include the product of the two variables as a new independent variable at step 52. Second, if the computer 36 determines that an independent-variable makes a U-shaped contribution to the dependent variable at step 54, the regression model may include both that variable and its square as independent variables at step 56. Third, if an independent variable is qualitative at step 58, a two-valued qualitative variable (e.g., gender) may be represented by a single “dummy” variable valued as a 0 or 1 at steps 60 and 62. If a qualitative variable has three or more possible values (e.g., locations of machines on the casino floor), the computer 36 may choose one value as the “base case” and create one 0-or-1-valued “difference” variable for each other value at step 64. The coefficient of each difference variable represents the difference between the associated value and the base case. Fourth, if the computer 36 determines that the relationship being studying is multiplicative rather than additive at step 66, the regression model may include logarithms of all of the variables at step 68 such that, for example:

Y=α·X₁^{β}^{₁}·X₂^{β}^{₂}·X₃^{β}^{₃}·ε

transforms to

log (Y)=α′+β₁·log (X₁)+β₂·log (X₂)+β₃·log (X₃)+ε′

Using a commercially available software package, the trend analysis computer 36 may execute a repetitive procedure, known as stepwise regression, at step 70 to aid it in the development of a regression model. Stepwise regression yields a regression model at step 72, which in turn regresses a dependent variable Y of the model onto one or more independent variables X₁, . . . , Xₖ at step 74.

In a “forward” stepwise regression analysis, the computer 36 begins by examining every possible simple linear regression model and determining the one with the highest coefficient of determination. Keeping the independent variable just selected for the first model, the computer 36 next examines every two-independent-variables model that includes the already-selected variable and one other, and determines the one with the highest coefficient of determination. And so on, adding one variable at a time, the computer 36 eventually provides a sequence of models it deems worthy of consideration.

In a “backwards” stepwise regression analysis, the trend analysis computer 36 begins with the regression model including all of the potential independent variables, and successively discards those that cost the least in terms of reduction of the coefficient of determination. The sequence of models so generated may be different from that generated using a forward stepwise regression analysis.

In a “general” stepwise regression analysis, the trend analysis computer 36 tests variables in a more general way, including variables which look good and discarding them later if their contribution to the explanatory power of some later model is not too great, and eventually yields a single regression model. The single model depends on what criteria were specified for inclusion and exclusion of variables.

The trend analysis computer 36 may, for example, use techniques of both simple linear regression, multiple regression, and non-linear regression to study relationships between variables. Both linear regression and multiple regression are discussed in detail below. Non-linear regression aims to describe the relationship between a dependent variable and one or more independent variables in a non-linear fashion. Further information about non-linear regression may be obtained from commercially available statistics books.

The trend analysis computer 36 may use a simple (bivariate) linear regression model to study the relationship between two quantitative variables, X and Y. The fundamental assumption is that a linear relationship exists between the variables. Through regression analysis, the computer 36 then seeks to discover the precise nature of this relationship. Often, the purpose in seeking out the relationship is to use observed values of an easily measured variable (X, the independent variable) in order to predict the values of a less easily measured variable (Y, the dependent variable). In this case, the computer 36 seeks to regress Y onto X.

The assumed relationship is of the form: Y=α+βX+ε; that is, for each member of the population under study, Y is a linear function of X, combined with an additional residual error factor ε. Regression analysis consists of estimating the coefficients (α and β) in this relationship from a number of sample data points, (X₁, Y₁), . . . , (Xₙ, Yₙ). The predicted value of Y associated with a specific value of X is then Y_{pred}=a+bX, assuming that the mean residual is 0. The analytical techniques used in regression analysis, and interpretive statements about the results, are also based on a number of other assumptions explained in commercially available statistics books.

The trend analysis computer 36 estimates the regression coefficients from the sample data by determining the line that is the best “least-squares” fit to a scatter plot of data points. That is, the computer 36 finds the coefficients for which the total squared difference between observed values of Y and values of Y predicted using those coefficients is minimal. The formulas that yield this “best fit” are included in the software executed by the computer 36 and can be found in commercially available statistics books. Briefly, b is essentially the ratio between the covariance of X and Y and the variance of X, and a is determined from b and the means of X and Y in such a way that the regression line passes through the point (Xᵢ, Yᵢ).

A consequence of the above-noted estimation procedure is the following. The total squared deviations of observed values of Y about the mean of these values (i.e., SST or sum of squares, total) can be decomposed into two components:

(1) the total squared deviation of predicted values about the mean (i.e., SSR or sum of squares, regression); and

(2) the total squared deviation of observed values from predicted values (i.e., SSE or sum of squares, error).

This decomposition is analogous to the decomposition of sample squared deviation about the mean into within-group and between-group variation, in one-way (single factor) analysis of variance. The ratio r²=SSR/SST=1−SSE/SST is called the coefficient of determination, and indicates the fraction of total variation in Y which is “accounted for” by the regression equation Y=a+bX. The square root of the ratio r², given the same sign as b, is the sample correlation coefficient r. The correlation coefficient r is an estimate of the ratio between the covariance of X and Y, and the product of the standard deviations of X and of Y. The correlation coefficient r has a value between −1 and 1. The closer its value is to −1 or 1, the stronger the apparent linear relationship between X and Y.

Of central importance to the confidence in estimating Y from X is the standard deviation of the error term ε. The trend analysis computer 36 initially chooses the estimates a and b to make the mean of the error term ε equal to zero and to make the squared deviation from this mean, SSE, as small as possible. Consequently, the “natural” estimate of the variance of the error term, SSE/n, has a downward bias similar to that which arises when one estimates a population variance from squared deviations about a sample mean. This bias is compensated for by instead using the estimate SSE/(n−2). The square root of this is called the standard error of the regression and is denoted s_{ε}. This is simply an estimate of the standard deviation of the error term ε in the true regression equation.

It is because of the error term ε that the sample estimate b of the regression coefficient β may be incorrect; indeed, the greater the variance of the error term, the greater is the potential estimating error. This is counterbalanced by sample size: the larger the sample, the smaller the potential estimating error. An estimate of the standard deviation of the sample estimate b is S_{b}=s_{ε}/(square root of the total squared deviation of X about the mean observed value of X). The distribution of b is approximated by the t-distribution with n−2 degrees of freedom and, hence, is approximately normal for large samples. These results allow the trend analysis computer 36 to construct confidence intervals for β and to test hypotheses concerning β, e.g., the hypothesis that X and Y are (linearly) independent, or, equivalently, that β=0.

To evaluate the level of confidence concerning predictions from the linear regression equation, the trend analysis computer 36 considers two potential sources of error as described above. One source of error comes from the error term ε and relates to the inherent variability in Y not accounted for by the regression equation. The other source of error comes from potential error in the estimate of the regression coefficients. The effect of error in the estimate b of β is magnified as the “predicting” variable X moves away from the mean of X. The standard error of the prediction of Y from a particular value x of X is:

s_{pred}(x)=s_{ε}·+{square root over (1+1/n+(x−x)²/((n−1)sₓ²))}

The assumption that the error term is normally distributed implies that, for a fixed value of X, Y is normally distributed. Thus, the above result enables the trend analysis computer 36 to determine the confidence in predictions made using the linear regression equation.

It should be noted that the prediction equation could have been written in the form:

(Y_{pred}−Y)/s_{Y}=|b·sₓ/s_{Y}|·((X−X)/sₓ)

The bracketed expression is the correlation r_{xy} of X and Y. Therefore, the correlation coefficient indicates the number of “standard deviations” of change in Y that are “expected” to be associated with a one-standard-deviation change in X.

The trend analysis computer 36 uses the simple linear regression model to explore the nature of a hypothesized linear relationship between two random variables. Because the databases 40a-g contain data associated with more than two variables, the computer 36 may study the extent to which the variation in one of these variables can be explained in terms of the variations in some or all of the other variables. In order to do this, the computer 36 uses the techniques of multiple (multivariate) regression.

These multiple regression techniques differ little, in principal, from those of simple regression. The trend analysis computer 36 selects a group of “independent” variables and determine the linear expression of these which provides the best “least-squares” fit to the observed values of the “dependent” variable being studied. Each regression coefficient indicates the predicted average change in the dependent variable associated with a one-unit change in a particular independent variable. When normalized, i.e., when multiplied by the standard deviation of the independent variable and divided by the standard deviation of the dependent variable, the regression coefficients are called the “beta-weights” of the independent variables. Each beta-weight indicates the number of standard deviations of change in the dependent variable associated with a one-standard-deviation change in a particular independent variable. The ratio of explained variance to total variance of the dependent variable is the coefficient of multiple determination, and its positive square root is the coefficient of multiple correlation.

The standard error of estimate of the multiple regression equation is basically an estimate of the standard deviation of the error terms. If the trend analysis computer 36 makes assumptions about the error term analogous to those made in simple regression, then the computer 36 can estimate the standard errors of the regression coefficients, i.e., how much sampling error there is in the estimates of the “true” regression coefficients. Also, the computer 36 can formulate and test hypotheses such as whether a regression coefficient is equal to zero, i.e., the computer 36 can determine whether the computed coefficient is significantly different from zero. The standard error of a regression coefficient is determined by a formula that has in its denominator a factor indicating how much variation in that independent variable is not explained by variation in the other independent variables. Therefore, if one independent variable is closely “linked” to the others in a linear fashion, the standard error of its regression coefficient will be quite large. As noted above, this situation is known as colinearity, which can complicate precise estimation of the individual regression coefficients. However, the standard error of the forecast need not be adversely affected.

Using “undirected” data mining and data warehousing techniques, it can be seen that the trend analysis computer 36 can identify previously unknown associations in the data collected in the databases 40a-g without any specific guidelines and even counterintuitive correlations. The trend analysis computer 36 provides accurate, timely, and useful information to operators such as casinos and other gaming establishments. The central server system 10 can use the valuable results derived from such analysis for configuration of the gaming network and, in particular, the features and functionality of the gaming machines 12 and computing devices 14 linked over the network. The machines 12 and devices 14 are configured to optimize the entertainment experience and maintain the interest of players and/or maximize the performance and profitability of the machines 12 and devices 14.

While the present invention has been described with reference to one or more particular embodiments, those skilled in the art will recognize that many changes may be made thereto without departing from the spirit and scope of the present invention.

For example, instead of optimizing the gaming machines 12 and computing devices 14 in response to configuration commands from the central server system 10, each gaming machine 12 and computing device 14 may run its own statistical analysis software and optimize itself.

Furthermore, the trend analysis computer 36 may be assisted by the judgement of a human operator to help address such problems as specification bias and colinearity. Via a user interface, the operator can direct the trend analysis computer 36 to include or exclude certain variables from a regression analysis.

In addition, after the central server system configures the gaming network based on trends identified by the trend analysis computer 36, the trend analysis computer 36 may perform a post-statistical analysis of subsequently collected data to validate the identified trends. If the post-statistical analysis reveals a discrepancy between such data and the trends, the trend analysis computer 36 may modify the relevant regression model by an appropriate correction term.

Each of these embodiments and obvious variations thereof is contemplated as falling within the spirit and scope of the claimed invention, which is set forth in the following claims:

What is claimed is:

1. A method of configuring gaming machines, comprising:
collecting, in at least one database, data associated with a plurality of variables, the plurality of variables including a dependent variable and a plurality of independent variables, the dependent variable being indicative of performance of the gaming machines;
analyzing the data with an electronic trend analyzer that uses inferential statistics to analyze the data;
identifying a previously unknown relationship between the dependent variable and one or more of the independent variables; and
configuring the gaming machines based on the identified relationship.

2. The method of claim 1, wherein the plurality of variables including a plurality of player tracking variables specific to individual players who play the gaming machines.

3. The method of claim 2, wherein the plurality of player tracking variables are selected from a group consisting of player background, player preferences, tracked casino/hotel usage, and tracked game usage.

4. The method of claim 2, wherein the step of collecting data includes collecting player tracking data, associated with the player tracking variables, from the players.

5. The method of claim 1, wherein the dependent variable is selected from a group consisting of profit, utilization, credits in, credits out, credits played, credits won, number of games played, average number of credits wagered, and median number of credits wagered.

6. The method of claim 1, wherein the gaming machines are linked to a host computer system over a network, and wherein the step of configuring the gaming machines includes transmitting configuration commands from the host computer system to the machines.

7. The method of claim 1, wherein the step of configuring the gaming machines occurs automatically without operator intervention.

8. The method of claim 1, further including receiving a personal identifier from a player at one of the gaming machines, and wherein the step of configuring the gaming machines includes automatically configuring the one of the gaming machines in response to the step of receiving a personal identifier.

9. The method of claim 1, wherein the step of using inferential statistics includes regressing the dependent variable onto the one or more of the independent variables.

10. The method of claim 9, wherein the step of using inferential statistics includes specifying a regression model for regressing the dependent variable onto the one or more of the independent variables.

11. The method of claim 10, wherein the step of using inferential statistics includes executing stepwise regression prior to the step of specifying the regression model.

12. The method of claim 10, wherein the regression model is a multiple regression model, and wherein the step of using inferential statistics includes regressing the dependent variable onto two or more of the independent variables.

13. The method of claim 10, wherein the regression model includes logarithms of the dependent variable and the one or more of the independent variables.

14. The method of claim 10, wherein the regression model includes a product of two of the independent variables as a new independent variable onto which the dependent variable is regressed.

15. The method of claim 10, wherein the regression model includes a square of at least one of the one or more of the independent variables as a new independent variable onto which the dependent variable is regressed.

16. A system of configuring gaming machines, comprising:
one or more databases for storing data associated with a plurality of variables, the plurality of variables including a dependent variable and a plurality of independent variables, the dependent variable being indicative of performance of the gaming machines;
an electronic trend analyzer for using inferential statistics to identify a previously unknown relationship between the dependent variable and one or more of the independent variables; and
a host computer system, linked to the gaming machines, for configuring the gaming machines based on the identified relationship.

17. The system of claim 16, wherein the plurality of variables including a plurality of player tracking variables specific to individual players who play the gaming machines.

18. The system of claim 17, wherein the player tracking variables are selected from a group consisting of player background, player preferences, tracked casino/hotel usage, and tracked game usage.

19. The system of claim 17, wherein the one or more databases store player tracking data associated with the player tracking variables, the player tracking data being collected from the players.

20. The system of claim 16, wherein the dependent variable is selected from a group consisting of profit, utilization, credits in, credits out, credits played, credits won, number of games played, average number of credits wagered, and median number of credits wagered.

21. The system of claim 16, wherein the host computer configures the gaming machines by transmitting configuration commands to the machines.

22. The system of claim 16, wherein the host computer configures the gaming machines automatically without input from an operator.

23. The system of claim 16, wherein the host computer automatically configures one of the gaming machines in response to receiving a personal identifier from a player at the one of the gaming machines.

24. The system of claim 16, wherein the trend analyzer regresses the dependent variable onto the one or more of the independent variables.

25. The system of claim 24, wherein the trend analyzer specifies a regression model for regressing the dependent variable onto the one or more of the independent variables.

26. The system of claim 25, wherein the trend analyzer executes stepwise regression to aid the trend analyzer in specifying the regression model.

27. The system of claim 25, wherein the regression model is a multiple regression model, the trend analyzer regressing the dependent variable onto two or more of the independent variables.

28. The system of claim 25, wherein the regression model includes logarithms of the dependent variable and the one or more of the independent variables.

29. The system of claim 25, wherein the regression model includes a product of two of the independent variables as a new independent variable onto which the dependent variable is regressed.

30. The system of claim 25, wherein the regression model includes a square of at least one of the one or more of the independent variables as a new independent variable onto which the dependent variable is regressed.

31. A method of configuring a network of gaming machines, comprising:
collecting, in at least one database, data associated with a plurality of variables, the plurality of variables including a dependent variable and a plurality of independent variables, the dependent variable being indicative of performance of wagering games conducted via the gaming machines;
analyzing the data with an electronic trend analyzer that uses inferential statistics to analyze the data;
identifying a previously unknown relationship between the dependent variable and one or more of the independent variables; and
configuring the network of gaming machines based on the identified relationship.

32. The method of claim 31, wherein the step of configuring the network of gaming machines includes configuring which of the wagering games are available for play on which of the gaming machines.
